(19) United States
(12) Patent Application Publication
(10) Pub. No.: US 2009/0039748 A1
(43) Pub. Date: Feb. 12, 2009

(54) Positioning mechanism

(75) Inventor: Yi-Hsuan Chen, Taipei (TW)

Correspondence Address: EDWARDS ANGELL PALMER & DODGE LLP, P.O. BOX 55874, BOSTON, MA, 02205, US

(73) Assignee: Inventec Corporation, Taipei City (TW)

(21) Appl. No.: 11/890,981

(22) Filed: Aug. 8, 2007

(51) Int. Cl. A47B 88/00; G11B 5/008

(52) U.S. Cl. 312/350

(57) ABSTRACT

The present invention provides a positioning mechanism for positioning an object in a frame having a guiding groove. The object has a plurality of protruding portions. The positioning mechanism includes a first guiding portion disposed on a surface of the frame, and a positioning element having a second guiding portion engaged with the first guiding portion. The positioning element moves in a direction intersecting the guiding groove, such that the protruding portions of the object engage with the guiding groove. The positioning mechanism of the present invention is simpler and easier to be assembled and disassembled than a conventional positioning mechanism.

### BACKGROUND OF THE INVENTION

1. Field of the Invention

The present invention relates to positioning mechanisms, and more particularly, to a positioning mechanism for use with a frame.

2. Description of the Prior Art

Due to advances in technology, consumers look forward to electronic products that can be assembled and disassembled in a rapid, time-saving, and labor-saving manner. However, the prior art teaches positioning a device in a frame by screws, for example, fastening an object, such as a data storage device, to a drive frame by screws (as shown in FIG. 1). Referring to FIG. 1, a host housing 10 includes a frame 12, and the frame 12 has a plurality of positioning holes 121 laterally formed thereon. A data storage device 14 is fastened to the frame 12 by a plurality of screws 16, such that a plurality of data storage devices 14 can be extendably assembled in the host housing 10. However, in such assembling process of the prior art, the screws 16 are screwed into the positioning holes 121 of the frame 12, and into locking holes 141 on the flank of the data storage devices 14 by means of a screwdriver, so as to secure the data storage devices 14 in position. Likewise, in such disassembling process of the prior art, the screws 16 on the frame 12 are unscrewed by means of a screwdriver in order to remove the data storage devices 14 from the frame 12. As a result, the assembling process and disassembling process of the prior art are inconvenient.

In order to eliminate the inconvenience inherent to the prior art as mentioned above, Taiwan Patent No. M309129 discloses a resilient plate disposed on a frame for securing an object in position, wherein the resilient plate is formed with an engaging hole for engagement with a positioning bump of the object to be secured to the frame, as shown in FIGS. 2 and 3. Referring to FIG. 2, a resilient plate 18 is formed with a fixing hole 20 and an engaging hole 22, and one end of the resilient plate 18 is formed with a guiding plate 24, wherein the guiding plate 24 is used as an easy-grip, slightly upward bend to facilitate the assembling and disassembling of the resilient plate 18. Referring to FIG. 3, two lateral sides of a data storage device 34 are formed with a plurality of positioning bumps 36 corresponding in position to locking holes 341, wherein each of the positioning bumps 36 is a bolt or a screw, and the data storage device 34 is a hard disk drive, a floppy disk drive, or a CD-ROM drive. The resilient plate 18 is secured to the external surface of a frame 32 in a host housing 30 by means of screws or rivets, and the engaging hole 22 engages with one of the positioning bumps 36 on the flank of the data storage device 34, thus securing the data storage device 34 to the frame 32.

As described above, Taiwan Patent No. M309129 discloses resilient plates disposed on bilateral sides of a frame and configured for engagement with positioning bumps, so as to secure a data storage device in position. However, to disassemble the resilient plates disclosed in Taiwan Patent No. M309129, it is necessary to apply a relatively great force to the guiding plates of the resilient plates for separating the resilient plates from the positioning bumps. Another drawback of Taiwan Patent No. M309129 is that, since the resilient plates are disposed on the bilateral sides of the frame, panels covering both sides of a host housing have to be removed from the host housing before disassembling the positioning bumps, and also while assembling the positioning bumps. As a result, both the assembling and disassembling of the positioning bumps disclosed in Taiwan Patent No. M309129 are inconvenient.

Accordingly, an issue calling for an urgent solution is to provide a positioning mechanism to be easily assembled and disassembled without any tool and therefore overcome the drawbacks of the prior art.

### SUMMARY OF THE INVENTION

In light of the aforesaid drawbacks of the prior art, it is a primary objective of the present invention to provide a positioning mechanism to be easily assembled and disassembled.

Another objective of the present invention is to provide a positioning mechanism to be assembled and disassembled without any tool.

Yet another objective of the present invention is to provide a positioning mechanism with labor-saving assembling and disassembling thereof.

In order to achieve the above and other objectives, the present invention discloses a positioning mechanism for positioning an object in a frame, wherein the object has at least one protruding portion. The positioning mechanism includes a first guiding portion disposed on a surface of the frame, a positioning element and a resilient element disposed between the frame and the positioning element. The positioning element includes a second guiding portion corresponding in position to and engaging with the first guiding portion for moving in a direction intersecting the guiding groove, a positioning recess for engaging with and positioning the protruding portion, a slanted guiding portion adjacent to a front end of the positioning recess, and an operating portion for operating the positioning element to move in the same direction as the positioning recess is disengaged from the protruding portion.

Preferably, the positioning element is crossly coupled to one end or the middle portion of the guiding groove. Once the protruding portion abuts against the slanted guiding portion, the protruding portion moves along a slanted guiding surface of the slanted guiding portion and relatively to the positioning element. The resilient element is a spring or a leaf spring. The positioning element is further formed with an operating portion and a disengaging portion, wherein the disengaging portion is perpendicular to the slanted guiding portion and has a slanted surface. Once the protruding portion reaches a disengaging location, the protruding portion abuts against the disengaging portion and moves along and relatively to the slanted surface of the disengaging portion. The protruding portion is a bolt or a stud.

The positioning mechanism of the present invention can be assembled and disassembled easily, in a labor-saving manner, and without any tool, and therefore the drawbacks of the prior art are overcome.

### BRIEF DESCRIPTION OF THE DRAWINGS

FIG. 1 (PRIOR ART) is a schematic view showing a conventional positioning mechanism for a data storage device;

FIG. 2 (PRIOR ART) is a schematic view showing a resilient plate of a conventional positioning mechanism for a data storage device;

FIG. 3 (PRIOR ART) is a schematic view showing a conventional leaf spring-equipped positioning mechanism for a data storage device;

FIG. 4 is an exploded perspective view showing a positioning mechanism for a data storage device of the present invention;

FIGS. 5A to 5C are schematic views showing how a protruding portion moves relatively to a positioning element for a data storage device in the first preferred embodiment of the present invention; and

FIGS. 6A to 6D are schematic views showing how a protruding portion moves relatively to a positioning element for a data storage device in the second preferred embodiment of the present invention.

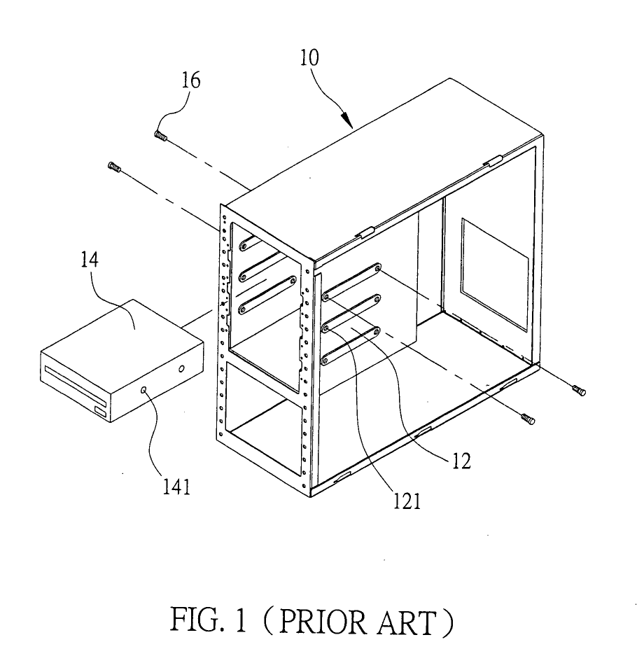

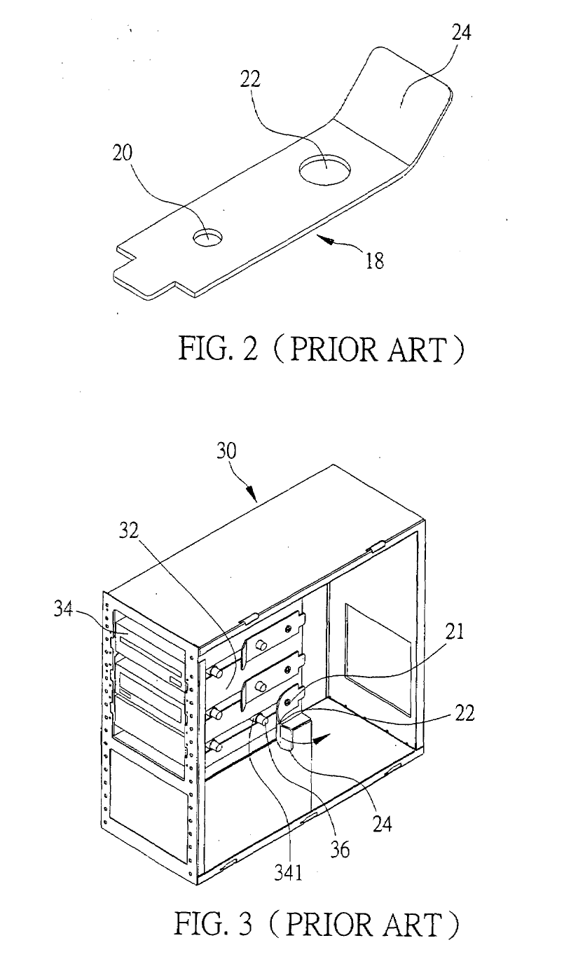

### DETAILED DESCRIPTION OF THE PREFERRED EMBODIMENTS

The following specific embodiments are provided to illustrate the present invention. Persons skilled in the art can readily gain insight into other advantages and features of the present invention based on the contents disclosed in this specification.

### The First Preferred Embodiment

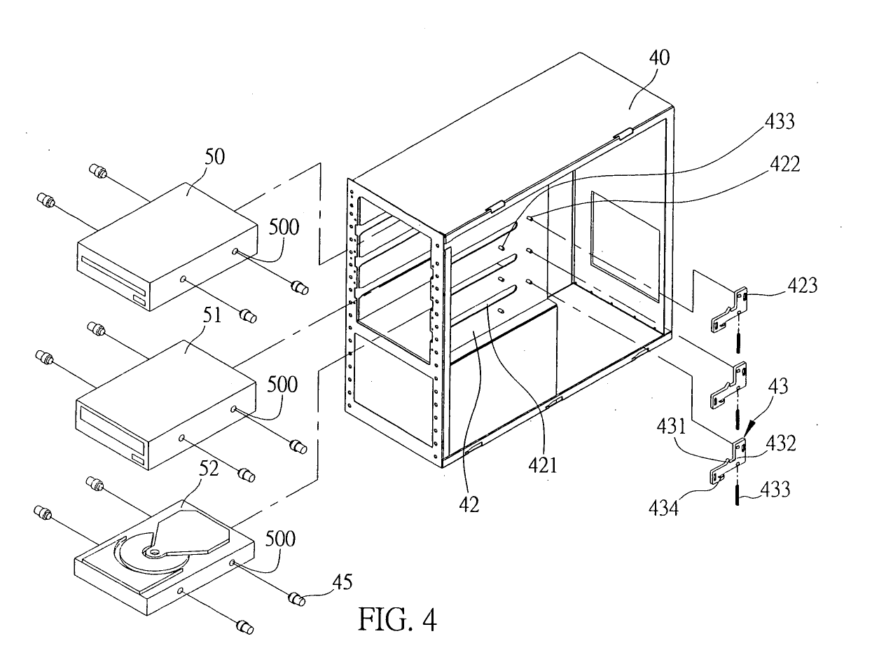

Referring to FIG. 4, which is an exploded perspective view showing a positioning mechanism in the first preferred embodiment of the present invention, the positioning mechanism is configured to position an object in a frame 42 of a host housing 40. The guiding grooves 421 are formed on the bilateral sides of the frame 42. The object has a protruding portion 45 slidably disposed in the guiding groove 421. In the first preferred embodiment, the positioning mechanism includes the frame 42 having a plurality of guiding grooves 421 formed on two sides of the frame 42. A first guiding portion 422 is disposed on a surface of the frame 42 and is near the guiding grooves 421. The positioning mechanism further includes a positioning element 43 and a resilient element 433. The positioning element 43 includes a second guiding portion 423 corresponding in position to and engaging with the first guiding portion 422. The positioning element 43 is capable of moving in a direction intersecting the guiding grooves 421. The positioning element 43 further includes a positioning recess 432, a slanted guiding portion 431, and an operating portion 434. The positioning recess 432 corresponds in position to and engages with the protruding portion 45. The slanted guiding portion 431 is adjacent to the front end of the positioning recess 432 and is configured to push, guide and move the protruding portion 45. The operating portion 434 is configured to operate the positioning element 43 to move in the same direct ion as the positioning recess 432 is disengaged from the protruding portion 45. The resilient element 433 of the positioning mechanism is disposed between the frame 42 and the positioning element 43 and is configured to provide resilience required to restore the displaced positioning element 43 to an original position. The positioning mechanism may also include a plurality of positioning elements 43. Each of the positioning elements 43 is movably disposed in the frame 42, corresponding in position to and crossly coupled to one end of a corresponding one of the guiding grooves 421, wherein the end of the corresponding guiding groove 421 is deeper in the host housing 40 than the other end of the corresponding guiding groove 421. Alternatively, the object may have a plurality of protruding portions 45 slidably disposed in the guiding grooves 421. One end of each of the protruding portions 45 is fastened to the object. In this preferred embodiment, the object is a storage device, for example, a floppy disk drive 50, a CD-ROM drive 51, and a hard disk drive 52 as shown in the drawing, and the one end of each of the protruding portions 45 is fastened to a fixing hole 500 of the storage device. The storage device is placed in the frame 42, and then the protruding portions 45 fastened to the storage device slide into the guiding grooves 421 bilaterally formed in the frame 42, thus positioning the storage device in the frame 42. Also, the positioning element 43 of this preferred embodiment is further formed with an operating portion 434 for users to operate the positioning element 43.

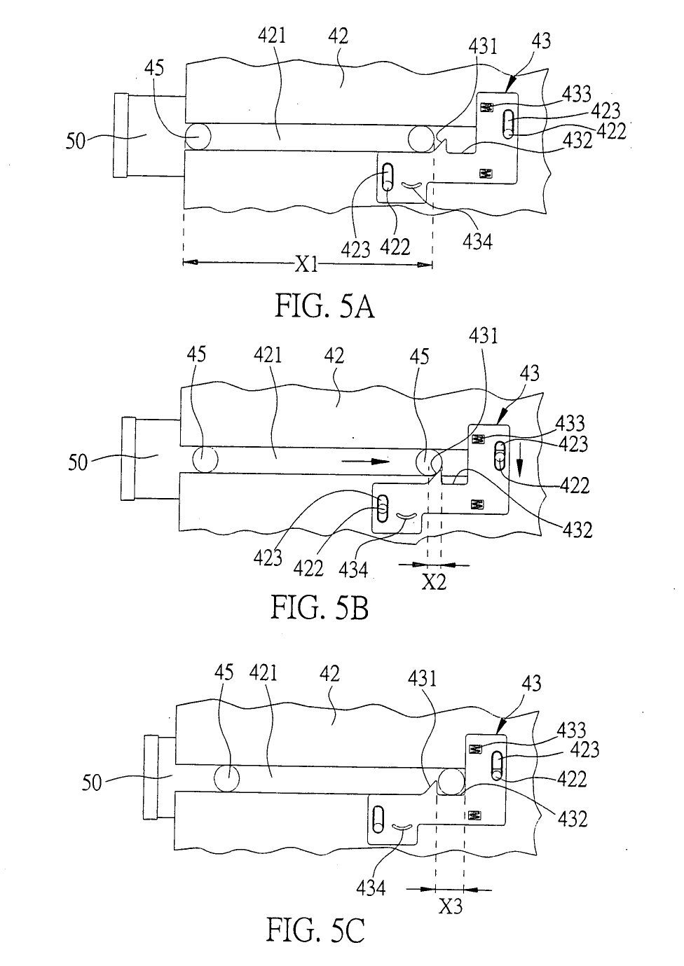

Referring to FIGS. 5A to 5C, which are schematic views showing how the protruding portion 45 moves relatively to the positioning element 43 for a data storage device in the first preferred embodiment of the present invention, the positioning mechanism for a data storage device of the present invention includes the positioning element 43 crossly coupled to the middle portion or one end of the guiding groove 421. The protruding portion 45 is fastened to the storage device and slidably disposed in the guiding groove 421, such that insertion of the protruding portion 45 fastened to the storage device into the guiding groove 421 formed in the frame 42 is followed in sequence by events described below, depending on the position of the protruding portion 45. At the first position. X1, the protruding portion 45 slides freely along the guiding groove 421 (as shown in FIG. 5A). At the second position X2, the protruding portion 45 abuts against the slanted guiding portion 431 of the positioning element 43 and moves along and relatively to the slanted guiding portion 431 (as shown in FIG. 5B), such that the resilient element 433 disposed between the frame 42 and the positioning element 43 is compressed under the movement of the protruding portion 45. At the third position X3, entry of the protruding portion 45 into the positioning recess 432 is followed by movement of the positioning element 43 relative to the protruding portion 45 under the resilience of the resilient element 433, and in consequence the protruding portion 45 engages with the slanted guiding portion 431 (as shown in FIG. 5C). Therefore, the objective to secure the protruding portion 45 in position is achieved.

### The Second Preferred Embodiment

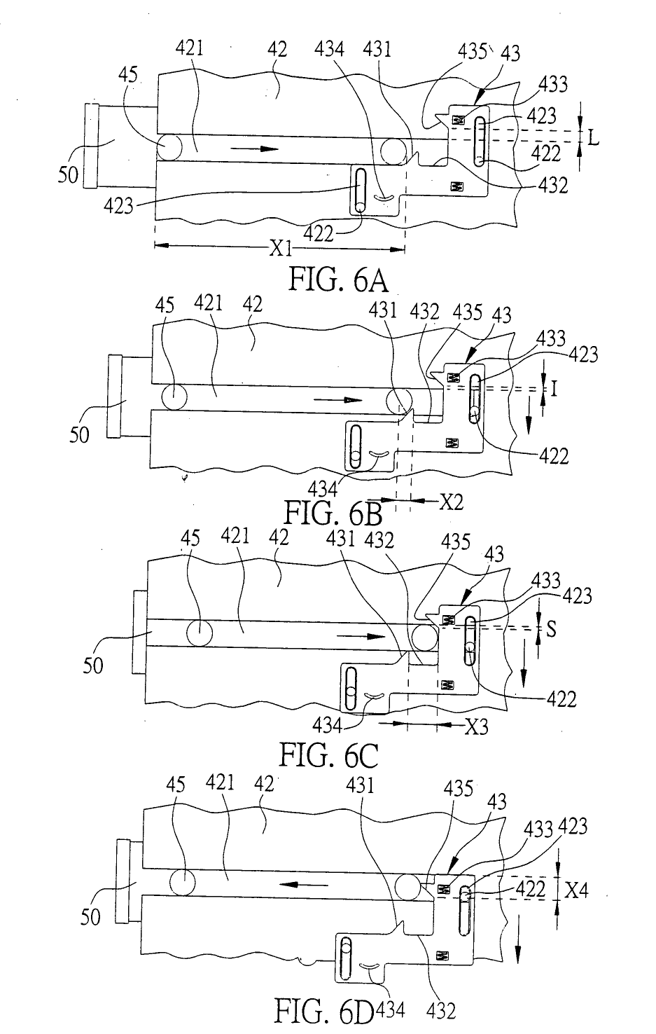

Referring to FIGS. 6A to 6D, which are schematic views showing how the protruding portion 45 moves relatively to the positioning element 43 for a data storage device in the second preferred embodiment of the present invention, a data storage device in the second preferred embodiment is mostly the same as that in the first preferred embodiment except that the positioning element 43 further comprises a disengaging portion 435 having a slanted guiding surface, wherein the slanted guiding surface of the disengaging portion 435 faces the positioning recess 432.

Events described below occur in sequence, depending on the position of the protruding portion 45. At the first position X1, the disengaging portion 435 is spaced apart from the guiding groove 421 by a distance L (as shown in FIG. 6A). At the second position X2, the disengaging portion 435 moves relative to the protruding portion 45 and is spaced apart from the guiding groove 421 by a distance I (as shown in FIG. 6B). At the third position X3, the disengaging portion 435 is eventually spaced apart from the guiding groove 421 by a distance S that enables the protruding portion 45 to enter the positioning recess 432 (as shown in FIG. 6C) where the protruding portion 45 is secured in position because of the interaction between the positioning element 43 and the resilient element 433. At the fourth position X4, the protruding portion 45 abuts against the disengaging portion 435 and moves along and relatively to the slanted guiding surface of the disengaging portion 435, and thus the protruding portion 45 is pushed out of the guiding groove 421 (in the direction indicated by a arrow shown in FIG. 6D). Therefore, the data storage device fastened to the protruding portion 45 can be removed from the frame 42. The advantage of the second preferred embodiment is as follows. While the data storage device is assembled in the frame 42 and users cannot grip the data storage device to remove the data storage device from the frame 42, the positioning mechanism in the second preferred embodiment is used for users to grip the data storage device to remove the data storage device from the frame 42 since the data storage device protrudes from the frame 42 by means of the disengaging portion 435.

The prior art discloses that a positioning pump is screwed in position by means of screws or leaf springs in a positioning mechanism for a data storage device, while the present invention discloses a positioning mechanism for a data storage device, wherein the positioning mechanism of the present invention includes a positioning element crossly coupled to the middle portion or one end of a guiding groove, a slanted guiding portion for securing a protruding portion fastened to the data storage device, a positioning recess, an operating portion, and a disengaging portion, such that the data storage device can be easily, swiftly disassembled, by pulling the operating portion and pushing the protruding portion out of the guiding groove by means of the disengaging portion.

The aforesaid embodiments merely serve as the preferred embodiments of the present invention. The aforesaid embodiments should not be construed as to limit the scope of the present invention in any way. Hence, many other changes can actually be made in the present invention. It will be apparent to those skilled in the art that all equivalent modifications or changes made to the present invention, without departing from the spirit and the technical concepts disclosed by the present invention, should fall within the scope of the appended claims.

What is claimed is:

1. A positioning mechanism for positioning an object in a frame having a guiding groove, wherein the object has a protruding portion slidably disposed in the guiding groove, the positioning mechanism comprising:
a first guiding portion disposed on a surface of the frame and near the guiding groove;
a positioning element comprising:
a second guiding portion corresponding in position to and engaging with the first guiding portion for moving in a direction intersecting the guiding groove;
a positioning recess for engaging with and positioning the protruding portion;
a slanted guiding portion adjacent to a front end of the positioning recess for pushing, guiding and moving the protruding portion; and
an operating portion for operating the positioning element to move in the same direction as the positioning recess is disengaged from the protruding portion; and
a resilient element disposed between the frame and the positioning element for providing resilience required to restore the positioning element to an original position from a further position.

2. The positioning mechanism of claim 1, wherein the positioning element is crossly coupled to one end of the guiding groove.

3. The positioning mechanism of claim 1, wherein the positioning element is crossly coupled to a middle portion of the guiding groove.

4. The positioning mechanism of claim 1, wherein the positioning element is moved in the same direction as the positioning recess is disengaged from the protruding portion by pushing the protruding portion against the slanted guiding portion.

5. The positioning mechanism of claim 1, wherein the resilient element is a spring.

6. The positioning mechanism of claim 1, wherein the resilient element is a leaf spring.

7. The positioning mechanism of claim 1, wherein the positioning element has a disengaging portion for disengaging the protruding portion from the positioning recess via the guiding groove.

8. The positioning mechanism of claim 7, wherein the disengaging portion is a slanted guiding surface corresponding to the positioning recess.

9. The positioning mechanism of claim 1, wherein the protruding portion is a bolt.

10. The positioning mechanism of claim 1, wherein the protruding portion is a stud.
